(19) United States
(12) Patent Application Publication
(10) Pub. No.: US 2016/0103434 A1
(43) Pub. Date: Apr. 14, 2016

(54) CONTROLLABLE HEALTH AND FITNESS DEVICE

(71) Applicants: Jeoff Drobot, Scottsdale, AZ (US); Jeff Katz, Scottsdale, AZ (US); Michael Sprauve, San Jose, CA (US); Steven Simas Escobar, San Jose, CA (US); Adrian Gutierrez, San Jose, CA (US)

(72) Inventors: Jeoff Drobot, Scottsdale, AZ (US); Jeff Katz, Scottsdale, AZ (US); Michael Sprauve, San Jose, CA (US); Steven Simas Escobar, San Jose, CA (US); Adrian Gutierrez, San Jose, CA (US)

(21) Appl. No.: 14/513,157

(22) Filed: Oct. 13, 2014

(51) Int. Cl. G05B 15/02; H04W 4/00

(52) U.S. Cl. CPC G05B 15/02; H04W 4/008

(57) ABSTRACT

A health and fitness device comprises a body configured to be worn on a body part such as a neck of a user. In some embodiments, the body is circular. The health and fitness device comprises one or more stimulus modules for providing a stimulus to the user and a control device for controlling the one or more modules. The health and fitness device is controllable through a smart phone and/or smart device and an application stored on the smart phone and/or smart device.

### FIELD OF THE INVENTION

The present invention is generally directed to health and fitness devices and systems. More particularly, the present invention is directed to a controllable health and fitness band that is worn by a user.

### BACKGROUND OF THE INVENTION

Many wearable health and fitness products are available in order to provide benefits for the user. Magnet and copper bands are often worn to reduce stiffness, while electronic bracelets and other products track fitness markers such as sleep, steps, heart rate and calories burned. Particularly, such products enable a user to increase physical activity and the overall health of the user. However, often times the products are not directly controllable by the user and do not provide a direct stimulus.

### SUMMARY OF THE INVENTION

A health and fitness device comprises a body configured to be worn on a body part such as a neck of a user. In some embodiments, the body is circular. The health and fitness device comprises one or more stimulus modules for providing a stimulus to the user and a control device for controlling the one or more modules. The health and fitness device is controllable through a smart phone and/or smart device and an application stored on the smart phone and/or smart device.

In one aspect a health and fitness device comprises a body configured to be worn on a body part of the user, one or more modules for providing a stimulus to the user and a control device for controlling the one or more modules. In some embodiments, the body is configured to be worn on the neck of the user. In some embodiments, a wireless receiver. In some of these embodiments, the wireless receiver is configured to receive one or more of an IEEE 802.11, bluetooth®, radio frequency, and infrared signal. The control device controls the one or more modules based upon the signal received by the wireless receiver. In some embodiments, the one or more modules comprises one or more of a module that distributes electromagnetic energy, a module that distributes an LED light, and a haptic motor. An intensity and the duration of the stimulus are adjustable. In some embodiments, each of the one or more modules is individually activatable. In some embodiments, the device comprises one or more of a recover setting, a relax setting, a sleep setting, a massage setting and an energize setting.

In another aspect, a health and fitness system comprises a transmitter and a body configured to be worn on a body part of the user, the body comprises one or more modules for providing a stimulus to the user, a wireless receiver, and a control device for controlling the one or more modules. In some embodiments, the body is configured to be worn on the neck of the user. In some embodiments, a wireless receiver. In some of these embodiments, the wireless receiver is configured to receive one or more of an IEEE 802.11, bluetooth®, radio frequency, and infrared signal. The control device controls the one or more modules based upon the signal received by the wireless receiver. In some embodiments, the one or more modules comprises one or more of a module that distributes electromagnetic energy, a module that distributes an LED light, and a haptic motor. An intensity and the duration of the stimulus are adjustable. In some embodiments, each of the one or more modules is individually activatable. In some embodiments, the device comprises one or more of a recover setting, a relax setting, a sleep setting, a massage setting and an energize setting. In some embodiments, the transmitter is located within a smart phone or smart device. In some of these embodiments, the transmitter sends a signal based upon an application running on the smart phone or smart device.

In a further aspect, a method of using a health and fitness device comprises placing the health and fitness device on a body part of a user, activating one or more modules of the device and for providing a stimulus to the user. The one or more modules are activated using one or an application stored on a smart phone. For example, in some embodiments, the application is utilized in order to adjust one or more settings of the one or more modules. Alternatively or in conjunction, the application is utilized in order to adjust an intensity and a duration of the one or more modules. In some embodiments, the one or more modules comprise one or more of a module that distributes electromagnetic energy, a module that distributes an LED light, and a haptic motor with the application.

In a further aspect, a health and fitness system comprises a body configured to be worn on a body part of the user, the body comprising one or more modules for providing a stimulus to the user, a receiver and a control device, and an application stored on a smart phone or smart device and used for controlling the one or modules of the system. In some embodiments, a user activates one or more of a module that distributes electromagnetic energy, a module that distributes an LED light, and a haptic motor with the application. Alternatively or in conjunction, a user adjusts the intensity and the duration of the stimulus using the application. The application is able to comprise one or more of a recover setting, a relax setting, a sleep setting, a massage setting and an energize setting.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIGS. 1A and 1B illustrate a health and fitness device in accordance with some embodiments.

FIGS. 2A and 2B illustrate the interior components of a health and fitness device in accordance with some embodiments.

FIG. 3 illustrates a schematic view showing the settings for use with a health and fitness device in accordance with some embodiments.

FIGS. 4A-4C illustrate one or more control screens for use with a health and fitness device in accordance with some embodiments.

FIG. 5 illustrates a schematic view of a health and fitness device in accordance with some embodiments.

FIG. 6 illustrates a health and fitness device in use in accordance with some embodiments.

FIG. 7 illustrates a method of using a health and fitness device in accordance with some embodiments.

### DETAILED DESCRIPTION OF THE EMBODIMENTS

Embodiments of the invention are directed to a health and fitness device configured to be worn around a body part of a user, such as the user's neck. The health and fitness device comprises one or more modules for providing a stimulus to the user and a control device for controlling the one or more modules. In some embodiments, the health and fitness device is controllable through a smart phone and/or smart device.

Reference will now be made in detail to implementations of a controllable health and fitness device. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

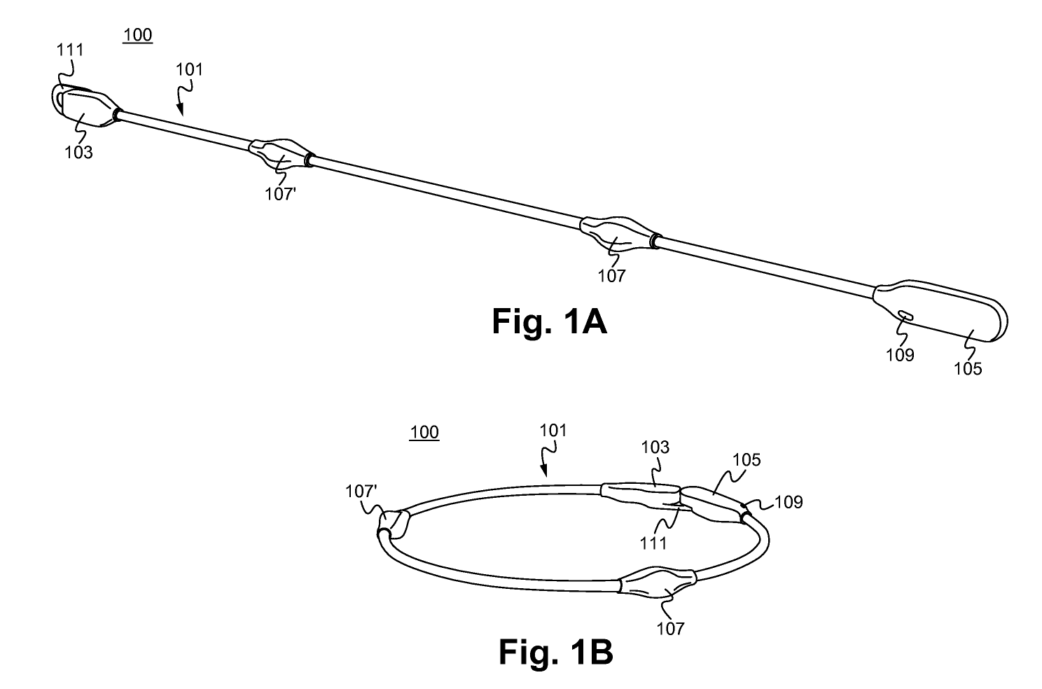

Referring now to FIGS. 1A and 1B, a health and fitness device is depicted therein. The health and fitness device 100 comprises a body 101 comprising a first end 103, a second end 105, a first module 107 and a second module 107′. Although two modules are shown in FIG. 1A, the health and fitness device 100 is able to comprise more or less modules as appropriately desired. As further shown in FIG. 1A, the health and fitness device 100 comprises a button 109 and a clasp 111 for removably coupling with the second end 105. In some embodiments, the button 109 is a power button. In some embodiments, the button 109 is a sync button, which when pushed causes the device to synchronize with a mobile device running an application controlling the health and fitness device 100. In some embodiments, the clasp 111 comprises a magnet for removably coupling with a complementary side of the second end 105. However, the health and fitness device 100 is able to comprise any appropriate coupling mechanism for coupling the first end 103 with the second end 105.

FIG. 1B, illustrates the health and fitness device 100 in a closed configuration, with the first end 103 coupled to the second end 105. In a closed configuration, the health and fitness device 100 forms a circular body which is configured to be positioned and/or placed over a body part of a user. In the closed position, the clasp enables the device 100 to pivot with the body for extra comfort. In some embodiments, the health and fitness device 100 is configured to be placed over a neck of the user. When the health and fitness device 100 is worn by the user, the one or more modules 107 and 107′ provide a stimulus to the user. In some embodiments, the one or more modules 107 and 107′ are coupled to the body 101 so that they are symmetrically opposed to each other when worn by a user.

In some embodiments, the health and fitness device is worn in an open configuration with no clasp such that the health and fitness device is draped over a body part of the user.

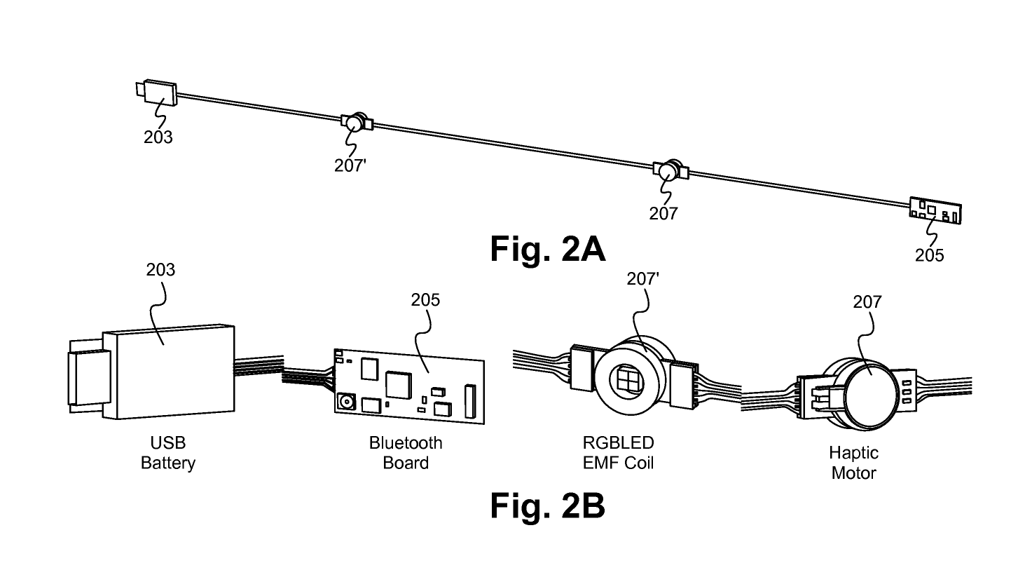

FIGS. 2A and 2B illustrate the inner components and circuitry of a health and fitness device in accordance with some embodiments. As shown in FIG. 2A, the device 200 comprises a body comprising a first end 203, a second end 205, a first module 207 and a second module 207′, such as described above.

As shown in FIG. 2B, in some embodiments, the first end 203 comprises a USB port and battery for charging and providing power to the health and fitness device 200 and the second end 205 comprises a receiver for receiving a wireless control signal. For example, in some embodiments, the receiver is configured for receiving one or more of IEEE 802.11, bluetooth®, radio frequency, infrared or any other appropriate wireless methodology. The receiver is configured to receive a signal to control the one or more modules 207 and 207′.

As further shown in FIG. 2B, in some embodiments, the module 207 comprises a haptic motor and the module 207′ comprises an LED light module and an electromagnetic energy generator. In some embodiments, the haptic motor is activated to arouse the nervous system of the wearer, initiating action and a hormonic combustion. In some embodiments, the electromagnetic energy is activated in order to activate ions in the blood and the LED light is activated to emit red, green and blue LED lights that placebically heal and energize. Particularly, the modules are able to comprise any appropriately desired modules for delivering an appropriate stimulus to a user.

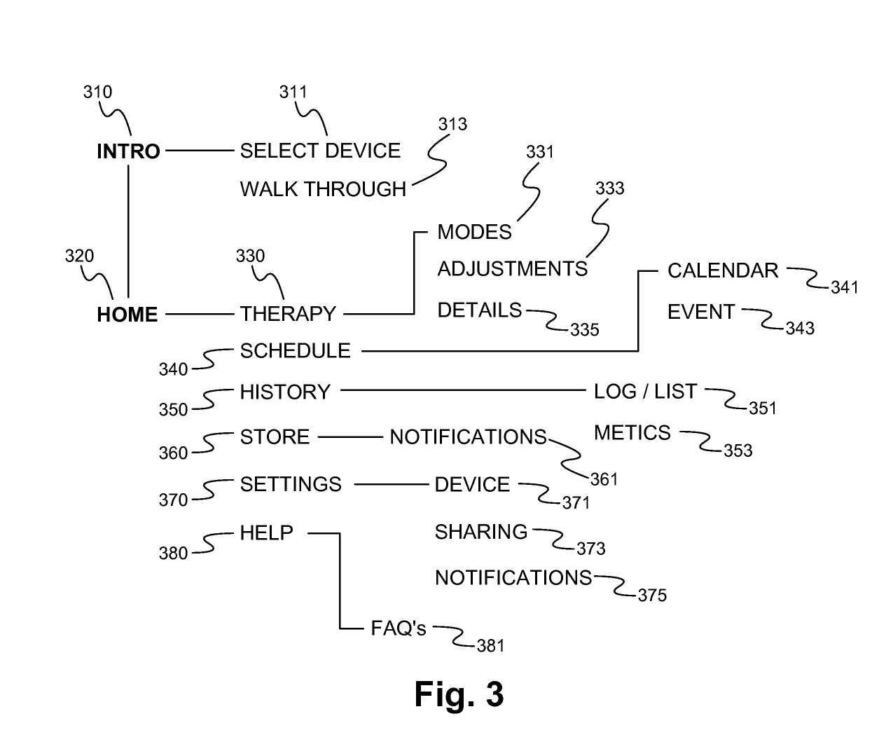

As described above, in some embodiments, the health and fitness device is configured for receiving a wireless control signal for controlling the one or more modules of the health and fitness device. In some embodiments, the wireless control signal is sent from a smart phone and/or other smart device running an application. FIG. 3 illustrates an example control interface showing the settings for use with a health and fitness device.

As shown within FIG. 3, the control interface comprises an intro 310 where a user is able to either select a device 311 or select a walk through 313 for the program. At a home screen 320, the user is able to select a therapy 330, select a schedule 340, view a use history 350, select a store 370 for in application purchases, adjust the settings 370 and select a help screen 380 where the user is able to view frequently asked questions 381 about the device and program. At the therapy screen 330, a user is able to select a mode of activation 331, adjust the mode of activation 333 and view the details 335. For example, in some embodiments, a user is able to select between a heal mode, a boost mode, and a relax mode, choose the timing, and also the intensity of a session. At the schedule page 340, the user is able to select an event 343 and/or view a calendar 341 that shows past and/or future scheduled sessions. The history page 350 shows a log and/or a list of past health and fitness sessions 351 as well as metrics 353 for the sessions. In some embodiments, the store page 360 provides one or more notifications 361 to the user regarding the device and the settings page 370 allows a user to change device settings 371, sharing settings 373, and notification settings 375. Particularly, the control interface enables a user to choose and/or adjust the settings of a health and fitness device.

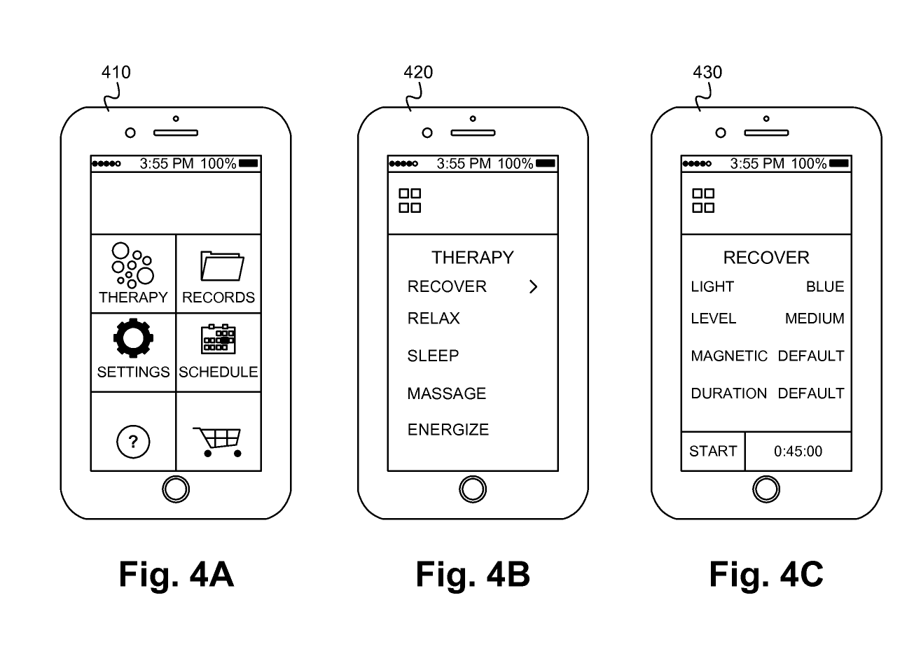

Referring now to FIGS. 4A-4C, one or more control screens are shown for use with the health and fitness device, such as described above. As described above, in some embodiments, the health and fitness device is controlled by an application running on a smart phone or other smart device. As shown within FIG. 4A, the screen 410 enables a user to choose a therapy, adjust the settings, ask a question, shop, view a schedule and view records. For example, if the user chooses the therapy tab, then as shown in the window 420, then the user is able to choose between a recover mode, a relaxation mode, a sleep mode, a massage mode, and an energize mode. However, more or less modes are able to be offered as appropriately desired. As shown within FIG. 4C, after choosing the desired mode, a user is able to choose and/or adjust the settings 430.

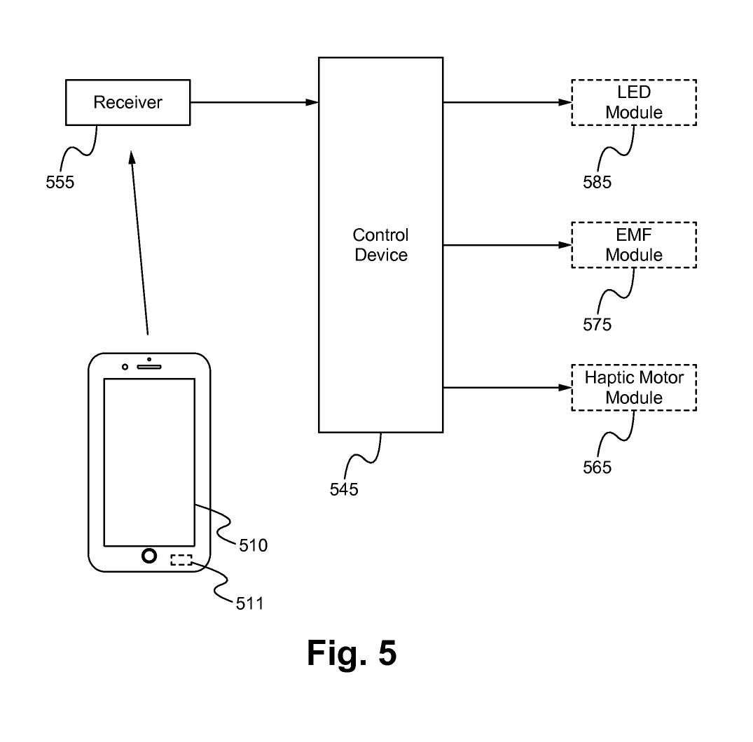

FIG. 5 illustrates a schematic view of a health and fitness system in accordance with some embodiments. The health and fitness system comprises a wireless transmitter 511, a receiver 555 for receiving a wireless signal, a control device, and one or more modules for providing a stimulus to a user. In some embodiments, the receiver 555, the control device 545, and the one or more stimulus modules are implemented within a wearable device, such as the health and fitness device 100, and 200, as described above. In some embodiments, the transmitter 511 transmits a wireless signal from a smart phone or a smart device 510 based upon an application running on the smart phone or smart device 510. In some embodiments, the wireless signal comprises one or more of IEEE 802.11, bluetooth®, radio frequency, infrared or any other appropriate wireless methodology.

Upon receiving a signal from the transmitter 511, the receiver 555, sends a signal to the control device 545 which operates one or more stimulus modules. As described above, in some embodiments, the one or more stimulus modules comprise one or more of a LED module 585, an electromagnetic energy generator 575, and a haptic motor module 565. For example, in some embodiments, the transmitter 511 transmits a signal to the receiver 555 to emit a blue and green LED light for a period of time. The receiver 555 receives the signal from the transmitter 511 and sends a signal to control device 545 which sends a signal to the LED module in order to emit a blue and green LED light for the period of time. Alternatively or in conjunction, the control device 545 receives and sends a signal to operate the electromagnetic energy generator 575, and the haptic motor module 565.

As described above, an application stored on the smart phone or smart device 510 is able to be used to control the duration, settings, time and/or intensity of the LED module 585, the electromagnetic energy generator 575, and the haptic motor module 565 using an application stored on the smart device. Using the application, through, the screens such as shown above, a user selects desired modes, duration, intensity, and other desired settings and characteristics. Based upon the settings chosen by the user, the application, then sends a signal to the receiver 555, and the control device 545 for controlling the health and fitness device. This enables the user, to for example set a desired setting, then go for a run, relax, sleep, or even complete a particular task, while the application continues to control the health and fitness device. Particularly, the smart device 510 is able to be used to control a health and fitness device as appropriately desired by a user. For example, in some embodiments, each of the one or more modules is individually activatable. In some embodiments, the device comprises one or more of a recover setting, a relax setting, a sleep setting, a massage setting and an energize setting.

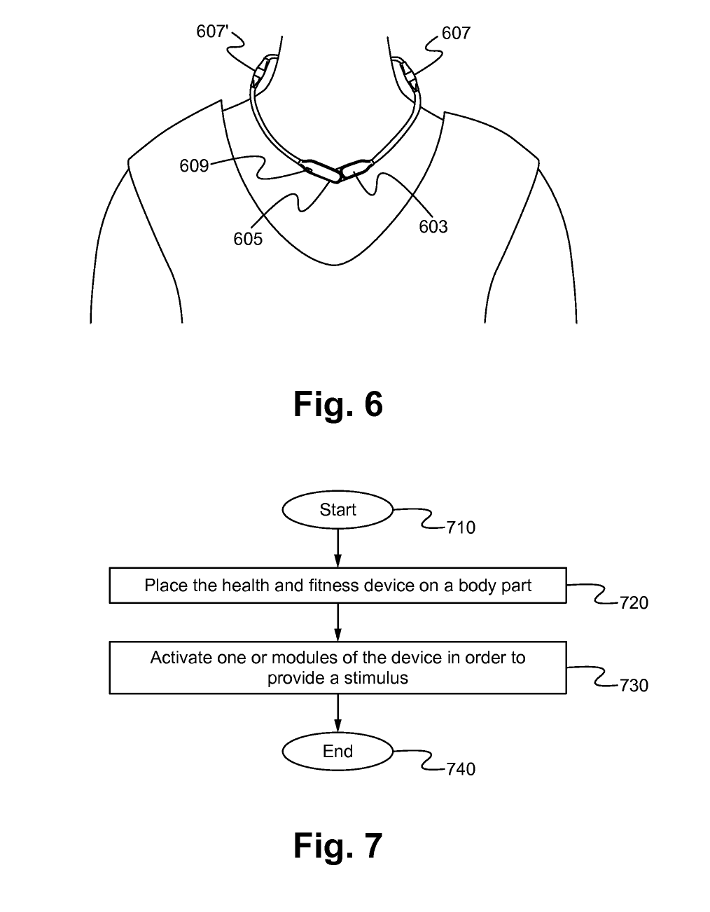

FIG. 6 illustrates a health and fitness device 600 being worn around a neck of a user. As shown within FIG. 6, the first end 603 is removably coupled to the second end 605 in order to form a circular body around a neck of a user. In the closed position, the clasp enables the device 600 to pivot with the body for extra comfort. When the health and fitness device 600 is worn by the user, the one or more modules 607 and 607′ provide a stimulus to the user. In some embodiments, the one or more modules 607 and 607′ are placed on the wearer's body 606 so that they are symmetrically opposed to each other when worn. In some embodiments, the health and fitness device is worn in an open configuration with no clasp such that the health and fitness device is draped over a body part of the user.

FIG. 7 illustrates a method of using a health and fitness device. The method begins in the step 710. In the step 720, the health and fitness device is placed on a body part of the user. For example, in some embodiments, the health and fitness device is placed around the neck of the user. Then in the step 730, one or more stimulus modules of the device is activated. For example, in some embodiments, one or more of an LED module, an electromagnetic energy generator, and the haptic motor module is activated. In some embodiments, the method further comprises adjusting a duration and/or intensity of the one or more stimulus modules.

In operation, a health and fitness device is able to be placed around a body part such as a neck in order to provide a stimulus to the user. The health and fitness device comprises one or more modules for providing a stimulus to the user and a control device for controlling the one or more modules. The health and fitness device is controllable through a smart phone and/or smart device. Additionally, one or more settings such as heal, boost, and relax are customizable depending upon the mood of the user. Particularly the health and fitness device is customizable to the needs of the user is order to provide a healing process, a boost, and increase energy levels. In this manner, the health and fitness device is customizable to meet the needs of a user. Accordingly, the controllable health and fitness device as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically it will be apparent to someone of ordinary skill in the art that the invention is able to be customizable to any appropriate setting.

What is claimed is:

1. A health and fitness device comprising:
a. a body configured to be worn on a body part of the user;
b. one or more modules for providing a stimulus to the user; and
c. a control device for controlling the one or more modules.

2. The health and fitness device of claim 1, wherein the body is configured to be worn on the neck of the user.

3. The health and fitness device of claim 1, further comprising a wireless receiver.

4. The health and fitness device of claim 3, wherein the wireless receiver is configured to receive one or more of an IEEE 802.11, bluetooth®, radio frequency, and infrared signal.

5. The health and fitness device of claim 3, wherein the control device controls the one or more modules based upon the signal received by the wireless receiver.

6. The health and fitness device of claim 1, wherein the one or more modules comprises one or more of a module that distributes electromagnetic energy, a module that distributes an LED light, and a haptic motor.

7. The health and fitness device of claim 1, wherein the intensity and the duration of the stimulus are adjustable.

8. The health and fitness device of claim 1, wherein each of the one or more modules is individually activatable.

9. The health and fitness device of claim 1, wherein the device comprises one or more of a recover setting, a relax setting, a sleep setting, a massage setting and an energize setting.

10. A health and fitness system comprising:
a. a transmitter; and
b. a body configured to be worn on a body part of the user, the body comprising;
i. one or more modules for providing a stimulus to the user;
ii. a wireless receiver; and
iii. a control device for controlling the one or more modules.

11. The health and fitness system of claim 10, wherein the body is configured to be worn on the neck of the user.

12. The health and fitness system of claim 10, wherein the wireless receiver is configured to receive one or more of an IEEE 802.11, bluetooth®, radio frequency, and infrared signal.

13. The health and fitness system of claim 10, wherein the control system controls the one or more modules based upon the signal received by the wireless receiver.

14. The health and fitness system of claim 10, wherein the one or more modules comprises one or more of a module that distributes electromagnetic energy, a module that distributes an LED light, and a haptic motor.

15. The health and fitness system of claim 10, wherein the intensity and the duration of the stimulus are adjustable.

16. The health and fitness system of claim 10, wherein each of the one or more modules is individually activatable.

17. The health and fitness system of claim 10, wherein the system comprises one or more of a recover setting, a relax setting, a sleep setting, a massage setting and an energize setting.

18. The health and fitness system of claim 10, wherein the transmitter is located within a smart phone or smart device.

19. The health and fitness system of claim 18, wherein the transmitter sends a signal based upon an application running on the smart phone or smart device.

20. A method of using a health and fitness device comprising:
a. placing the health and fitness device on a body part of a user;
b. activating one or more modules of the device and for providing a stimulus to the user.

21. The method of claim 20, wherein the one or more modules are activated using an application stored on a smart phone.

22. The method of claim 21, wherein the application is utilized in order to adjust one or more settings of the one or more modules.

23. The method of claim 21, wherein the application is utilized in order to adjust an intensity and a duration of the one or more modules.

24. The method of claim 20, wherein the one or more modules comprise one or more of a module that distributes electromagnetic energy, a module that distributes an LED light, and a haptic motor with the application.

25. A health and fitness system comprising:
a. a body configured to be worn on a body part of the user, the body comprising;
i. one or more modules for providing a stimulus to the user;
ii. a receiver; and
ii. a control device; and
b. an application stored on a smart phone or smart device and used for controlling the one or modules of the system.

26. The health and fitness system of claim 25, wherein a user activates one or more of a module that distributes electromagnetic energy, a module that distributes an LED light, and a haptic motor with the application.

27. The health and fitness system of claim 25, wherein a user adjusts the intensity and the duration of the stimulus using the application.

28. The health and fitness system of claim 25, wherein the application comprises one or more of a recover setting, a relax setting, a sleep setting, a massage setting and an energize setting.
